(19) United States
(12) Patent Application Publication
(10) Pub. No.: US 2018/0083550 A1
(43) Pub. Date: Mar. 22, 2018

(54) MODULAR MULTI-LEVEL CONVERTER

(71) Applicants: LSIS CO., LTD., Gyeonggi-do (KR); SEOUL NATIONAL UNIVERSITY R&DB FOUNDATION, Seoul (KR)

(72) Inventors: Yong-Ho CHUNG, Gyeonggi-do (KR); Gum-Tae SON, Gyeonggi-do (KR); Seung-KI SUL, Seoul (KR); Jae-Jung JUNG, Seoul (KR); Sheng-hui CUI, Aachen (DE)

(21) Appl. No.: 15/474,144

(22) Filed: Mar. 30, 2017

(30) Foreign Application Priority Data
Sep. 22, 2016 (KR) 10-2016-0121774

(51) Int. Cl. H02M 7/487

(52) U.S. Cl. CPC H02M 7/487

(57) ABSTRACT

The present disclosure relates a modular multi-level converter (MMC) including two arms including different types of sub modules according to the respective arms, two sub controllers corresponding to the two arms, respectively and configured to separately control the two arms, respectively, and a central controller configured to determine a switching operation condition of the sub module and to output a switching signal corresponding to the switching operation condition to each of the two sub controllers, wherein the two sub controllers control the respective corresponding arms based on the switching signal and, upon receiving a voltage change switching signal for controlling a voltage applied to one of the two arms, change the voltage applied to one of the two arms based on the voltage change switching signal.

### CROSS-REFERENCE TO RELATED APPLICATIONS

This application claims the priority of Korean Patent Application No. 10-2016-0121774, filed on Sep. 22, 2016, in the Korean Intellectual Property Office, the disclosure of which is hereby incorporated by reference in its entirety.

### BACKGROUND

### 1. Technical Field

The present disclosure relates to a modular multi-level converter (MMC), and more particularly, to an MMC configured in such a way that an upper arm and a lower arm include different types of sub modules.

### 2. Description of the Related Art

Recently, a modular multi-level converter (MMC) as one type of a voltage type converter used in a high voltage direct current transmission (HVDC) system are attracting attention. The MMC is a device that converts DC power into AC power using a plurality of sub modules (SMs). The MMC may be operated by controlling each sub module in a charge, discharge, or bypass state. To this end, the MMC may include a plurality of sub modules. In general, the sub module may be configured with a half-bridge structure or a full-bridge structure.

FIGS. 1A to 1D are diagrams illustrating a topology structure of a conventional MMC.

FIG. 1A illustrates the case in which a sub module is configured with a half-bridge structure. MMCs with such topology were developed early in 2000. According to the developed MMCs, as illustrated in FIG. 1A, half-bridge structure sub modules may be connected in series and, thus, problems such as electromagnetic compatibility (EMC), electromagnetic interference (EMI), and system loss, which occur in existing voltage type topology using a pulse width modulation (PWM) method, may be overcome.

Compared with a full-bridge structure, with regard to a half-bridge structure, a low number of switch devices is used and, thus, the half-bridge structure is advantageous in terms of system loss and economic aspects and, a balancing algorithm of a capacitor voltage of a sub module is simply embodied according to a current direction and, thus, the half-bridge structure is advantageously controlled.

However, a half-bridge structure system is disadvantageously vulnerable with respect to DC fault. In detail, even if the half-bridge structure system is configured in such a way that a bypass thyristor and an arm reactor are connected in series or in parallel in order to shut off and reduce fault current, this is not a reliable measure with respect to fault of a DC terminal. In general, a half-bridge structure system uses a DC current breaker connected to a DC power transmission line in order to reduce over current due to fault of a DC terminal of the DC power transmission line. However, currently, there is a problem in that a DC current breaker has increased short circuit-current for several milliseconds (msec) and high manufacturing costs.

FIG. 1B illustrates the case in which a sub module is configured with a half-bridge structure and a high-power diode is installed at a DC terminal. In order to overcome the problems described with reference to FIG. 1A, a high power diode that withstands a high voltage is installed at a DC terminal as illustrated in FIG. TB and, thus, there is attempt to overcome DC fault by preventing opposite-direction current via the high power diode in the case of fault at the DC terminal. However, in this case, a problem occurs in terms of system loss, etc. in an excessive normal state.

FIG. 1C illustrates the case in which a sub module is configured with a full-bridge structure. When a structure of a sub module is changed to a full-bridge from a half-bridge, control freedom is enhanced. An output voltage of a full-bridge structure sub module may be controlled to +1 p.u., 0 p.u., and −1 p.u. Accordingly, when DC fault occurs, a voltage at a DC terminal is forcibly controlled via control of an output voltage of an arm so as to overcome DC over current. In addition, in the case of full-bridge structure topology, current flows through a capacitor of a DC power transmission line and, thus, the full-bridge structure topology of is topology with capability for shutting off fault current.

However, a full-bridge structure system includes sub modules configured with a full-bridge structure and, thus, the number of semiconductor devices is high and system loss is high during normal operation of a system, compared with a half-bridge structure system.

FIG. 1D illustrates the case in which sub module are configured with a half-bridge structure and a full-bridge structure. A half-bridge and a full-bridge coexist to constitute sub modules included in one arm. The half-bridge structure and full-bridge structure sub modules coexist and, thus, topology having all the advantages of FIGS. 1A and 1D may be configured. However, the topology has difficulty in voltage synthesis when a DC voltage is excessively lowered in a normal state. Furthermore, a half-bridge structure sub module and a full-bridge structure sub module need to be independently controlled with respect to one arm and, thus, there is a problem in terms of difficult and complex control.

### SUMMARY

It is an object of the present disclosure to provide a modular multi-level converter (MMC) configured in such a way that an upper arm and a lower arm include different types of sub modules and each arm includes only the same type of sub module and, thus, a direct current (DC) voltage is controlled to prevent DC over current in the case of DC fault and to apply the same control method to each arm.

It is an object of the present disclosure to provide a detailed control method for separately controlling each arm.

Objects of the present disclosure are not limited to the above-described objects and other objects and advantages can be appreciated by those skilled in the art from the following descriptions. Further, it will be easily appreciated that the objects and advantages of the present disclosure can be practiced by means recited in the appended claims and a combination thereof.

In accordance with one aspect of the present disclosure, a modular multi-level converter (MMC) includes two arms including different types of sub modules according to the respective arms, two sub controllers corresponding to the two arms, respectively and configured to separately control the two arms, respectively, and a central controller configured to determine a switching operation condition of the sub module and to output a switching signal corresponding to the switching operation condition to each of the two sub controllers, wherein the two sub controllers control the respective corresponding arms based on the switching signal and, upon receiving a voltage change switching signal for controlling a voltage applied to one of the two arms, change the voltage applied to one of the two arms based on the voltage change switching signal.

### BRIEF DESCRIPTION OF DRAWINGS

FIGS. 1A to 1D are diagrams illustrating a topology structure of a conventional modular multi-level converter (MMC).

FIG. 2 is a block diagram illustrating a structure of an MMC according to an exemplary embodiment of the present disclosure.

FIG. 3 is a diagram illustrating a connection structure of a plurality of sub modules included in an MMC according to an exemplary embodiment of the present disclosure.

FIGS. 4A and 4B are diagrams illustrating a structure of a sub module included in an MMC according to an exemplary embodiment of the present disclosure.

FIG. 5 is a diagram illustrating an example of a topology structure of an MMC according to an exemplary embodiment of the present disclosure.

FIG. 6 is a circuit diagram obtained by modeling a topology of an MMC according to an exemplary embodiment of the present disclosure.

FIGS. 7A and 7B are diagrams for explanation of a method of controlling an MMC according to an exemplary embodiment of the present disclosure;

FIG. 8 is a diagram illustrating the case in which direct current (DC) fault occurs in an MMC according to an exemplary embodiment of the present disclosure.

FIG. 9 is a diagram for explanation of a control method for controlling internal power of an MMC according to an exemplary embodiment of the present disclosure.

FIG. 10 is a diagram for explanation of a control method for maintaining internal power of an MMC according to another exemplary embodiment of the present disclosure.

FIG. 11 is a diagram for explanation of a control structure of an MMC according to an exemplary embodiment of the present disclosure.

FIG. 12 is a diagram illustrating a structure of a high voltage DC transmission (HVDC) system including an MMC according to an exemplary embodiment of the present disclosure.

### DETAILED DESCRIPTION

Reference will now be made in detail to embodiments, examples of which are illustrated in the accompanying drawings. However, technological spirit of the present disclosure is not limited to the following exemplary embodiments and may easily propose other retrogressive inventions or other exemplary embodiments included in the scope of the range of the technological spirit of the present disclosure by adding, modifying, deleting, etc. of other components.

Most of the terms used herein are general terms that have been widely used in the technical art to which the present disclosure pertains. However, some of the terms used herein may be arbitrarily chosen by the present applicant. In this case, these terms are defined in detail below. Accordingly, the specific terms used herein should be understood based on the unique meanings thereof and the whole context of the present disclosure. It will be further understood that the terms “comprises” or “comprising” are not intended to included all elements or all steps described herein, but do not preclude exclusion of some elements or steps described herein or addition of one or more other elements or steps.

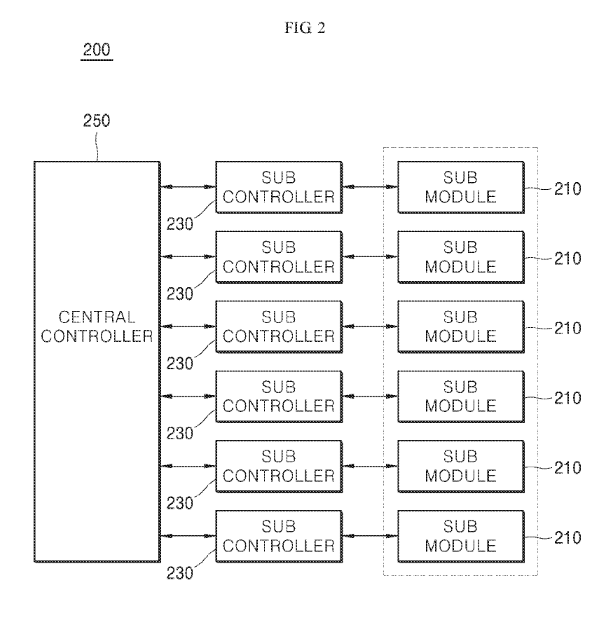

FIG. 2 is a block diagram illustrating a structure of a modular multi-level converter (MMC) 200 according to an exemplary embodiment of the present disclosure.

The MMC 200 according to an exemplary embodiment of the present disclosure may include a central controller 250, a plurality sub controllers 230, and a plurality sub modules 210.

The central controller 250 may control the plurality sub controllers 230 and each of the sub controllers 230 may control a corresponding one of the sub modules 210, which is connected to the corresponding sub controller 230. In this case, as illustrated in FIG. 2, one sub controller 230 may be connected to one sub module 210 and may control a switching operation of one sub module 210 connected to the corresponding sub controller 230 based on a control signal transmitted through the central controller 250. However, the present disclosure is not limited thereto. In some embodiments, one sub controller 230 may be connected to the plurality sub modules 210 and may control a switching operation of the plurality sub modules 210 connected to the corresponding sub controller 230 based on a plurality of control signals transmitted through the central controller 250.

The central controller 250 may determine an operation condition of the plurality sub modules 210 and generate a control signal for controlling operations of the plurality sub modules 210 based on the determined operation condition. Here, the operation condition may include conditions of a discharge operation, a charge operation, and a bypass operation. Here, the control signal may be a switching signal.

The central controller 250 may control an overall operation of the MMC 200, in detail, the central controller 250 may calculate a total control value of the MMC 200. Here, the total control value may include a target value of voltage, current, and frequency sizes of output direct current (DC) power or output alternating current (AC) power of the MMC 200, and so on.

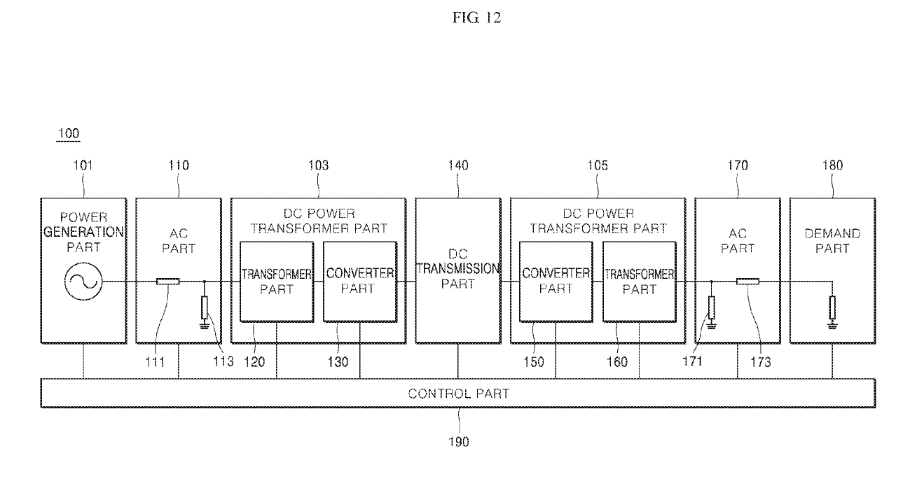

The MMC 200 according to an exemplary embodiment of the present disclosure may be included in a high voltage direct current transmission (HVDC) system 100 that will be described below with reference to FIG. 12 and may be used as a voltage type converter. When the MMC 200 is included in the HVDC system 100, the central controller 250 may measure current and voltage of each of a DC transmission part 140 and AC parts 110 and 170 that are associated with the MMC 200. In this case, the central controller 250 may calculate a total control value based on at least one of the measured current and voltage of each of the AC parts 110 and 170 and the DC transmission pail 140.

The central controller 250 may control an operation of the MMC 200 based on at least one of reference active power, reference reactive power, reference current, and reference voltage, which are received from a high-level controller (not shown) through a communication device (not shown).

The central controller 250 may transmit and receive data to and from the sub controllers 230. The data may be related to at least one of a control signal for controlling an operation of the plurality sub modules 210, state information of the plurality sub modules 210, and state information of the central controller 250.

In general, the plurality sub modules 210 may not be operated under the same switching condition but a specific sub module 210 may perform a charge operation or a bypass operation and the other sub modules 210 may perform a discharge operation according to currently required target voltage. Accordingly, the central controller 250 may determine a sub module 210 that performs each of the charge operation, the bypass operation, and the discharge operation.

Each of the plurality sub controllers 230 may receive a switching signal for controlling the plurality sub modules 210 from the central controller 250 and control a switching operation of each of the plurality sub modules 210 based on the received switching signal.

The plurality sub modules 210 may receive AC current or DC current and perform any one of the charge, discharge, and bypass operations. To this end, the sub module 210 may include a switching device including a diode. In this case, the sub module 210 may perform one of the charge, discharge, and bypass operations of the sub module 210 via a switching operation and a rectification operation of a diode.

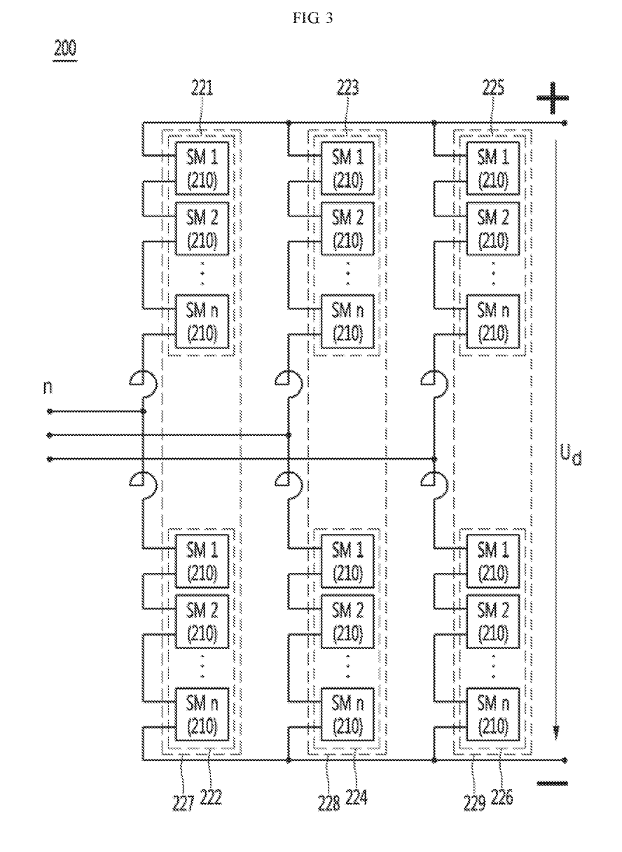

FIG. 3 is a diagram illustrating a connection structure of a plurality of sub modules included in an MMC 200 according to an exemplary embodiment of the present disclosure.

The MMC 200 according to an exemplary embodiment of the present disclosure may be a three-phase MMC 200.

The plurality sub modules 210 may be connected in series. In this case, the plurality of sub modules 210 that are connected to a positive or negative electrode in one phase may constitute one arm.

In general, the three-phase MMC 200 may include six arms. In detail, each of three phases U, V, and W may include a positive (+) electrode and a negative (−) electrode to constitute six arms. Referring to FIG. 3, the three-phase MMC 200 may include a first arm 221 including the plurality sub modules 210 for a U-phase positive electrode, a second arm 222 including the plurality sub modules 210 for a U-phase negative electrode, a third arm 223 including the plurality sub modules 210 for a V-phase positive electrode, a fourth arm 224 including the plurality sub modules 210 for a V-phase negative electrode, a fifth arm 225 including the plurality sub modules 210 for a W-phase positive electrode, and a sixth arm 226 including the plurality sub modules 210 for a W-phase negative electrode.

The plurality sub modules 210 for one phase may constitute a leg. Referring to FIG. 3, the three-phase MMC 200 may include a U-phase leg 227 including the plurality sub modules 210 for a U phase, a V-phase leg 228 including the plurality sub modules 210 for a V phase, and a W-phase leg 229 including the plurality sub modules 210 for a W phase.

In this case, each of the first arm 221 to the sixth arm 226 may be included in the U-phase leg 227, the V-phase leg 228, or the W-phase leg 229. In detail, the U-phase leg 227 may include the first arm 221 that is a U-phase positive arm and the second arm 222 that is a U-phase negative arm and the V-phase leg 228 may include the third arm 223 that is a V-phase positive electrode and the fourth arm 224 that is a V-phase negative arm. In addition, the W-phase leg 229 may include the fifth arm 225 that is a W-phase positive arm and the sixth arm 226 that is a W-phase negative arm.

According to another exemplary embodiment of the present disclosure, the plurality sub modules 210 may include a positive arm (not shown) and a negative arm (not shown) according to polarity. In detail, referring to FIG. 3, the plurality sub modules 210 included in the MMC 200 may be classified into the plurality sub modules 210 corresponding to a positive electrode and the plurality sub modules 210 corresponding to a negative electrode based on a neutral line n. In this case, the MMC 200 may include a positive arm (not shown) including the plurality sub modules 210 corresponding to a positive electrode and a negative arm (not shown) including the plurality sub modules 210 corresponding to a negative electrode. In this case, the positive arm (not shown) may include the first arm 221, the third arm 223, and the fifth arm 225 and the negative arm (not shown) may include the second arm 222, the fourth arm 224, and the sixth arm 226.

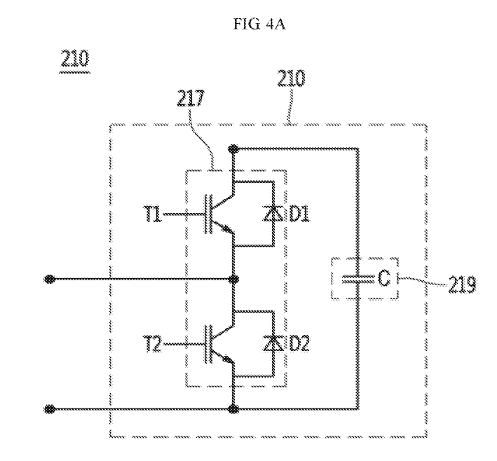

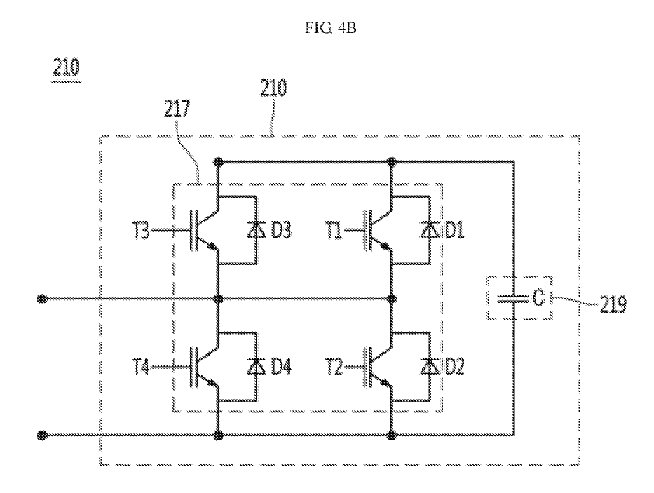

FIGS. 4A and 4B are diagrams illustrating a structure of a sub module included in an MMC according to an exemplary embodiment of the present disclosure.

In detail, FIG. 4A illustrates a half-bridge structure sub module 210 and FIG. 4B illustrates a full-bridge structure sub module 210.

As illustrated in FIG. 4A, the half-bridge structure sub module 210 may include a switching unit 217 and a storage unit 219.

The switching unit 217 may include two switches T1 and T2 and two diodes D1 and D2. Here, each of the switches T1 and T2 may include a power semiconductor. The power semiconductor refers to a semiconductor device for a power device and is optimized for power conversion or power control. The power semiconductor may also be called a valve device. In detail, a switch may include an insulated gate bipolar transistor (IGBT), a gate turn-off thyristor (GTO), an integrated gate commutated thyristor (IGCT), and so on.

The storage unit 219 may include a capacitor and discharge or charge energy.

The above configured half-bridge structure sub module 210 may be driven in a unipolar manner.

Referring to FIG. 4B, the full-bridge structure sub module 210 may include the switching unit 217 and the storage unit 219.

The switching unit 217 may include four switches T1, T2, T3, and T4 and four diodes D1, D2, D3, and D4. Here, each of the four switches T1, T2, T3, and T4 may include a power semiconductor. The power semiconductor has been described above with reference to FIG. 4A and, thus, a detailed description thereof will be omitted herein.

The storage unit 219 may include a capacitor and may charge or discharge energy.

The above configured full-bridge structure sub module 210 may be driven in a bipolar manner.

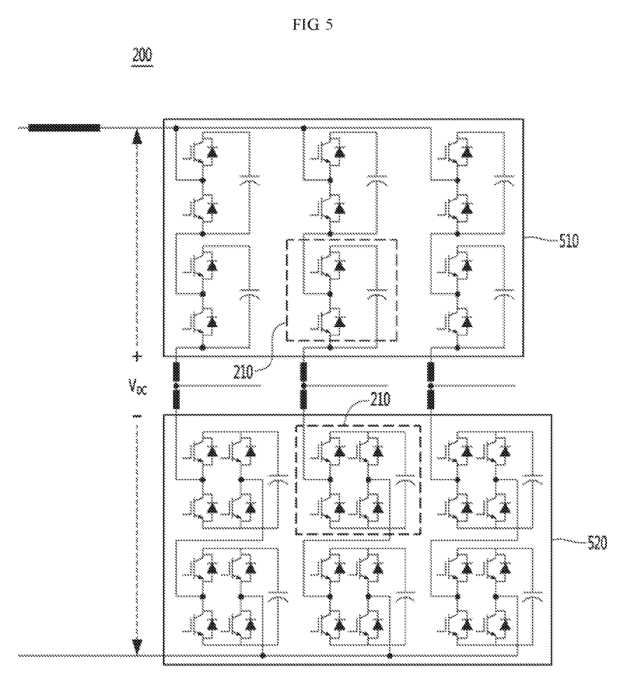

FIG. 5 is a diagram illustrating an example of a topology structure of an MMC according to an exemplary embodiment of the present disclosure.

The MMC 200 according to an exemplary embodiment of the present disclosure may include a plurality of arms that include different types of sub modules 210, respectively. In detail, a plurality of arms may include different types of sub modules, respectively. In this case, each arm may include the same type of sub modules.

Hereinafter, the above configured MMC 200 will be defined as an asymmetric MMC 200.

According to an exemplary embodiment of the present disclosure, the MMC 200 may include an upper arm and a lower arm. In this case, the upper arm and the lower arm may include different types of sub modules. Accordingly, sub modules included in the upper arm and the lower arm respectively may have different types.

The types of the sub module 210 may include a half-bridge type, a full-bridge type, a neutral point clamped (NPC) type, an FC type, and so on. Accordingly, in some embodiments, types of sub modules included in each arm may be variously configured.

According to an exemplary embodiment of the present disclosure, any-phase upper arm (positive arm) may include a first-type sub module and any-phase lower arm (negative arm) may include a second-type sub module. For example, an upper arm may include the half-bridge structure sub module 210 and a lower arm may include the full-bridge structure sub module 210. Alternatively, the upper arm may include the half-bridge structure sub module 210 and the lower arm may include an NPC type of the sub module 210. In addition, the upper arm may include an FC type of the sub module 210 and the lower arm may include the half-bridge structure sub module 210.

According to another exemplary embodiment of the present disclosure, for each phase, the upper arm and the lower arm may include different types of sub modules and types of sub modules may be separately or independently configured with respect to different phases. For example, a U-phase upper arm may include a half-bridge type sub module and a lower arm may include a full-bridge type sub module, a V-phase upper arm may include a full-bridge type sub module and a lower arm may include a half-bridge type sub module, and a W-phase upper arm may include a half-bridge type sub module and a lower arm may include an NPC type sub module.

However, the present disclosure is not limited thereto and, for example, an arm that belongs to each phase may include only the same type sub module 210 based on a combination of various-type sub modules 210.

Referring to FIG. 5, the MMC 200 may include an upper arm 510 and a lower arm 520. In this case, the upper arm 510 may include only the half-bridge structure sub module 210 and the lower arm 520 may include only the full-bridge structure sub module 210.

The upper arm and the lower arm include different types sub modules 210 and, thus, when DC fault occurs, DC over current may be prevented.

In general, when both the upper arm and the lower arm include the half-bridge structure sub module 210 (i.e., a unipolar driving method), it may be advantageous in terms of loss in a system but, when DC fault occurs, DC over current may not be prevented. On the other hand, when both the upper arm and the lower arm include the full-bridge structure sub module 210 (i.e., a bipolar driving method), DC over current may be remarkably prevented if DC fault occurs but loss in a system in a normal state may be doubled compared with a system using a unipolar driving method.

Accordingly, according to an exemplary embodiment of the present disclosure, the upper arm and the lower arm include different types of sub modules 210 that are the half-bridge or full-bridge structure sub modules 210 and the sub modules 210 included in each of the upper arm and the lower arm may have only one type. In this case, compared with topology in which both the upper arm and the lower arm include the full-bridge structure sub module 210, the number of switch devices may be reduced, reducing loss in a system. In addition, compared with topology in which both the upper arm and the lower arm include the half-bridge structure sub module 210, voltage of a DC end may be controlled to overcome DC over current.

According to an exemplary embodiment of the present disclosure, each arm may include the same type of sub modules 210. When different types of sub modules 210 coexist in one of arms, the sub modules 210 are separately controlled according to their types and, thus, it may be difficult to control a system. However, like in the present disclosure, when each arm includes only the same type of sub modules 210, the same control method may be applied to each arm and, thus, it may be easy to control a system.

Such an effect may also be achieved by configuring each arm based on a combination of various types of sub modules 210 according to various exemplary embodiments of the present disclosure, as described above with reference to FIG. 5.

In addition, the MMC 200 according to an exemplary embodiment of the present disclosure may be applied to a voltage type converter system and, in particular, to a voltage-type HVDC system product (Point to Point, Back to Back, and Multi-terminal). In this case, currently present various types of sub modules (full-bridge type, a sub module with a higher voltage control range than a half-bridge type, such as an NPC method or an FC method) may coexist with a half-bridge sub module and, thus, it may be possible to overcome DC fault.

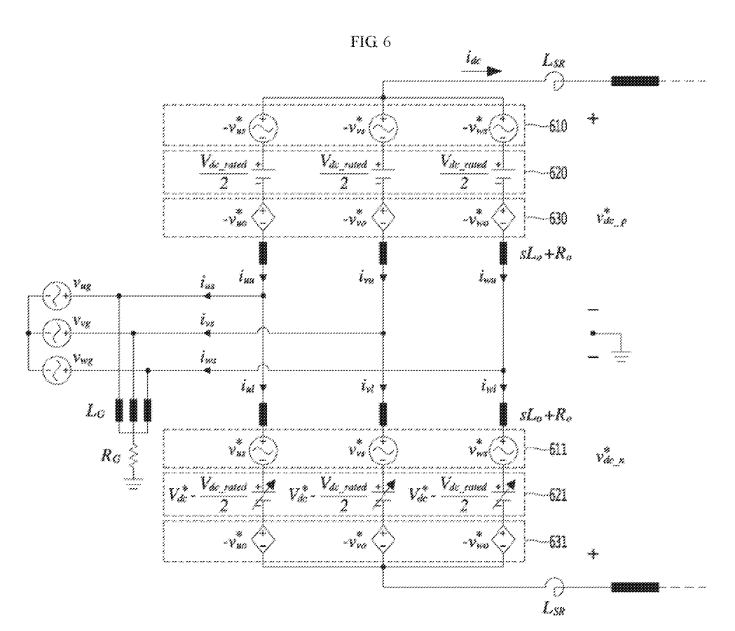

FIG. 6 is a circuit diagram obtained by modeling a topology of an MMC according to an exemplary embodiment of the present disclosure.

In order to explain a method of controlling the MMC 200 according to an exemplary embodiment of the present disclosure, the topology of the MMC 200 may be modeled in terms of a circuit. In detail, the topology of the MMC 200 may be modeled as a circuit including an alternating current (AC) power supply, a direct current (DC) power supply, and a circulating current power supply.

One arm may be represented by the sum of voltages of capacitors included in the arm and each arm may be considered as a separate voltage source. In this case, the MMC 200 may be considered as a system including six voltage sources.

Each arm may include V*ₓₛ 610 and 611 corresponding to the AC power source,

$$\frac{Vdc rated}{2}$$

620 and 621 corresponding to the DC power supply, and V*ₓₒ 630 and 631 corresponding to the circulating current power supply. Here, x may refer to three phases, in detail, a U-phase, a V-phase, and a W-phase. When the sum of circulating current power supplies of the respective phases is 0, values corresponding to the DC power supply, the AC power supply, and the circulating current power supply may be independently controlled. Accordingly, when an overall system may be controlled, the values may be configured via linear superposition.

In the case of an existing system including only the half-bridge structure sub module 210, that is, an MMC driven in a unipolar manner, a voltage reference voltage of each of an upper arm and a lower arm inevitably has a positive voltage (plus voltage, + voltage).

However, according to a topology of the MMC 200 according to an exemplary embodiment of the present disclosure, a size of a DC power terminal may be flexibly adjusted. For example, when a system is configured in such a way that an upper arm includes only the half-bridge structure sub module 210 and is driven in a unipolar manner and a lower arm includes only the full-bridge structure sub module 210 and is driven in a bipolar manner, a size of a DC power supply terminal at the lower arm may be flexibly adjusted. In detail, the lower arm may adjust a size of the DC power supply terminal within a range of

$$- \frac{Vdc rated}{2} to \frac{Vdc rated}{2} .$$

In this case, a DC voltage may be synthesized to voltage 0 via synthesis with a DC power supply value

$$\frac{Vdc rated}{2}$$

of the upper arm.

The DC voltage is synthesized to voltage 0 and, thus, DC fault occurs in the system, DC over current may be controlled to be prevented. Accordingly, system response with respect to DC over current may be increased and, accordingly, the system does not require a component such as a DC current breaker.

In some embodiments, when a system is configured in such a way that an upper arm includes only the full-bridge structure sub module 210 and is driven in a bipolar manner and a lower arm includes only the half-bridge structure sub module 210 and is driven in a unipolar manner, a size of a DC power supply terminal at the upper arm may be controlled.

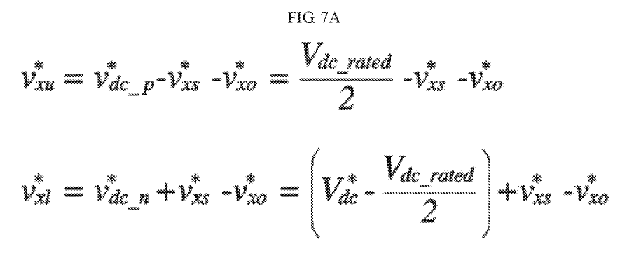

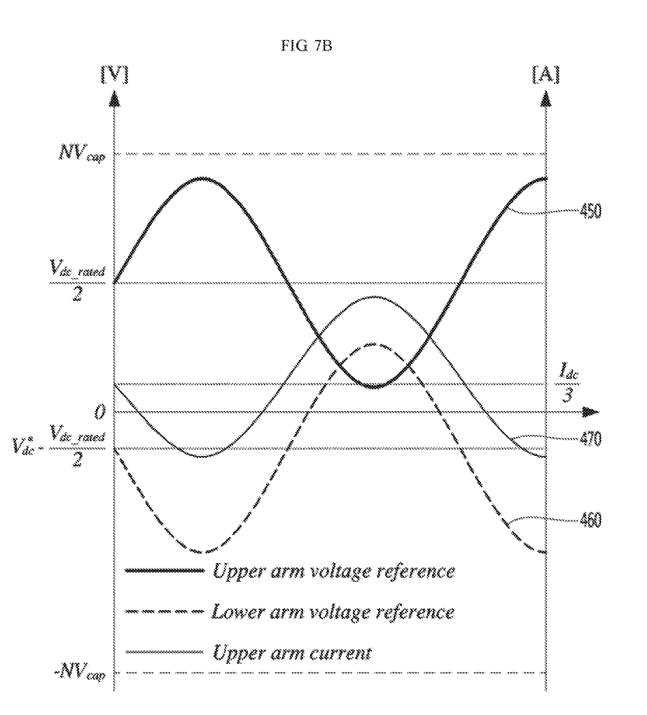

FIGS. 7A and 7B are diagrams for explanation of a method of controlling an MMC 200 according to an exemplary embodiment of the present disclosure.

A voltage reference value applied to each arm included in the MMC 200 may be given according to the following equation.

Voltage reference Value Applied to Arm=DC Voltage reference Value of Arm−AC Voltage reference Value of Arm−Internal Power Control Constant of Arm [Equation 1]

According to Equation 1 above, a voltage reference value applied to each of an upper arm and a lower arm may be given as follows.

Voltage reference Value V*ₓᵤ Applied to Upper Arm=DC voltage reference value V*_{dc}_{_}ₚ of Upper Arm−AC Voltage reference Value V*ₓₛ of Upper Arm−Internal Power Control Constant V*ₓₒ of Upper Arm [Equation 2]

Voltage reference Value V*ₓₗ Applied to Lower Arm=DC Voltage reference Value V*_{dc}_{_}ₙ of Lower Arm−AC Voltage reference Value V*ₓₛ of Lower Arm−Internal Power Control Constant V*ₓₒ of Lower Arm [Equation 3]

Here, the internal power control constant may correspond to the circulating current power supply described with reference to FIG. 6.

V*ₓᵤ and V*ₓₗ are voltage reference values of an upper arm and a lower arm with respect to each of three phases. Here, x refers three phases and, in detail, x may be one of u, v, and w.

When a voltage reference value of each of an upper arm and a lower arm with respect to each of three phases, that is, size command values are calculated, DC power control, AC power control, and MMC internal power control may be performed in the circuit illustrated in FIG. 6 based on the calculated voltage reference value.

For DC power control (in general, a plurality of stations is present), a DC voltage needs to be considered. In this case, a DC voltage reference value of an upper arm may be V*_{dc}_{_}ₚ and a DC voltage reference value of a lower arm may be V*_{dc}_{_}ₙ.

An AC voltage reference value for AC power control may be represented by V. The AC voltage reference value may be included in a voltage reference value of each of the upper arm and the lower arm and AC voltage reference values of the upper arm and the lower arm may have opposite signs. A difference between a DC terminal voltage (i.e.,

$$+ \frac{Vdc rated}{2} , - \frac{Vdc rated}{2} )$$

and an arm command value is an AC voltage and, thus, in the case of an upper arm, a sign of an AC voltage reference value needs to be determined as minus (−), and in the case of a lower arm, a sign of an AC voltage reference value needs to be determined as plus (+).

V*ₓₒ is an internal power control constant. All six arms are separately controlled and, thus, in order to maintain six arms at a constant value, an internal power control constant may be set. A symmetric MMC is used to maintain a rated DC voltage and, thus, the symmetric MMC may use a command value for DC power control as a fixed value

or use current obtained by slightly changing DC current for DC power

$$\frac{Vdc rated}{2}$$

on control. On the other hand, an asymmetric MMC very easily changes a voltage of an arm driven in a bipolar manner to change an overall system voltage (i.e., DC fault occurs or, in the case of a current-type HVDC system, a DC voltage may be changed in order to maintain DC current) and, thus, a voltage applied to a DC terminal may be set to

$${V}_{d c}^{′} - \frac{Vdc rated}{2} .$$

Accordingly, a detailed formula for obtaining a voltage reference value V*ₓᵤ applied to an upper arm and a voltage reference value V*ₓₗ applied to a lower arm may be derived as illustrated in FIG. 7A.

FIG. 7B shows voltage reference values and arm current values of an upper arm and a lower arm when a voltage of a DC terminal becomes lower than a rated voltage. In FIG. 7B, a hold plot 450 indicates a voltage reference value of an upper arm and a bold dotted line plot 460 indicates a voltage reference value of a lower arm. In addition, a solid line plot 470 indicates a current value of an upper arm.

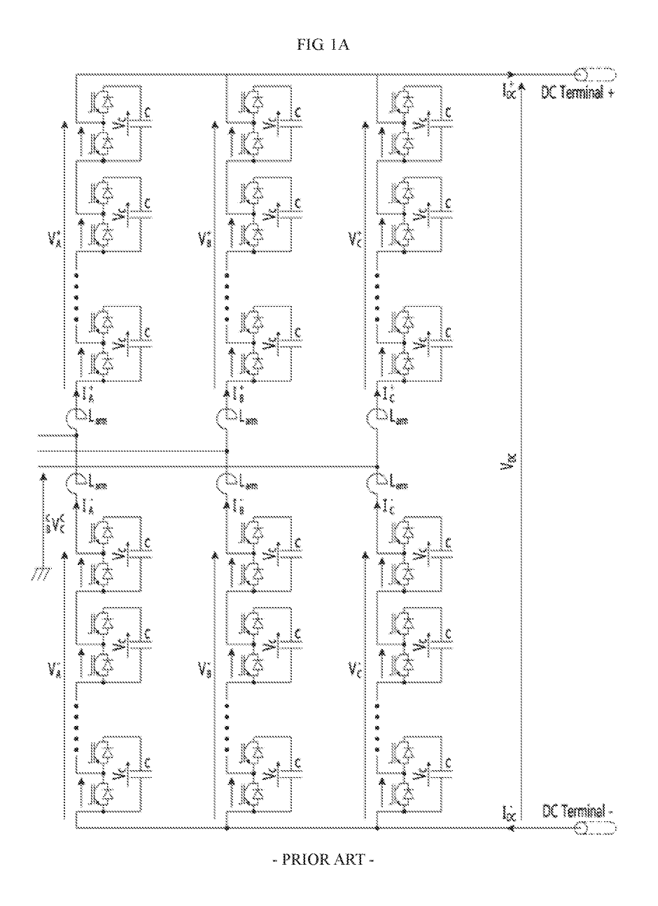

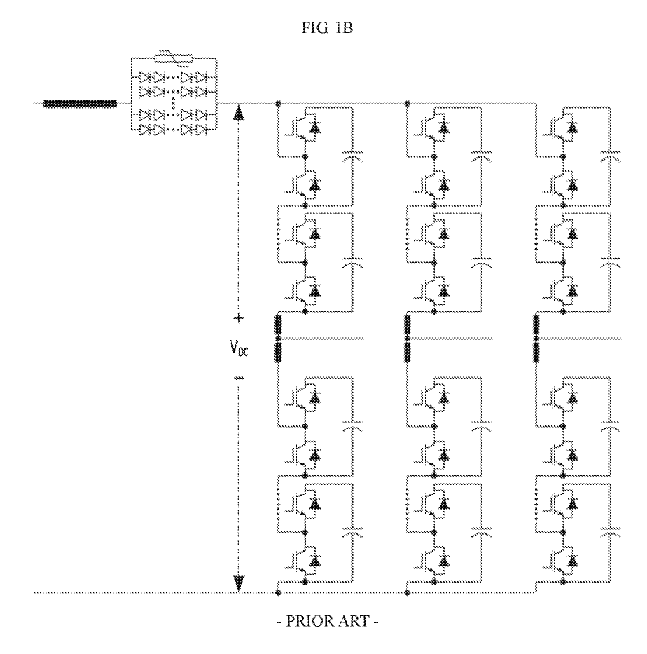

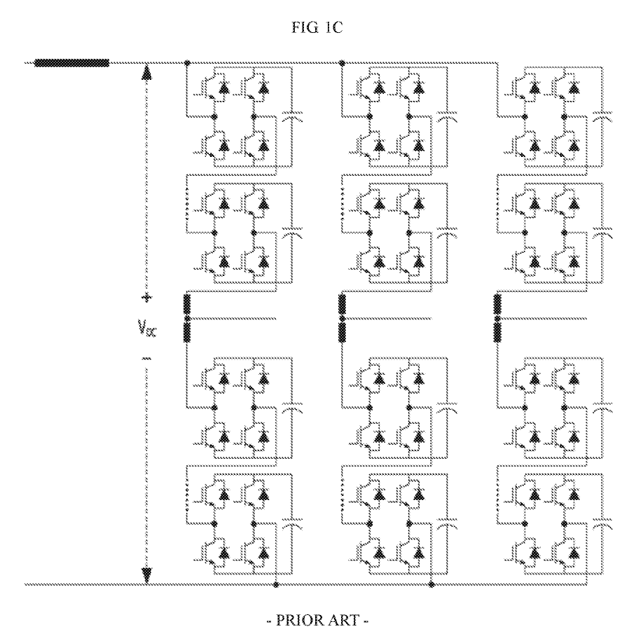

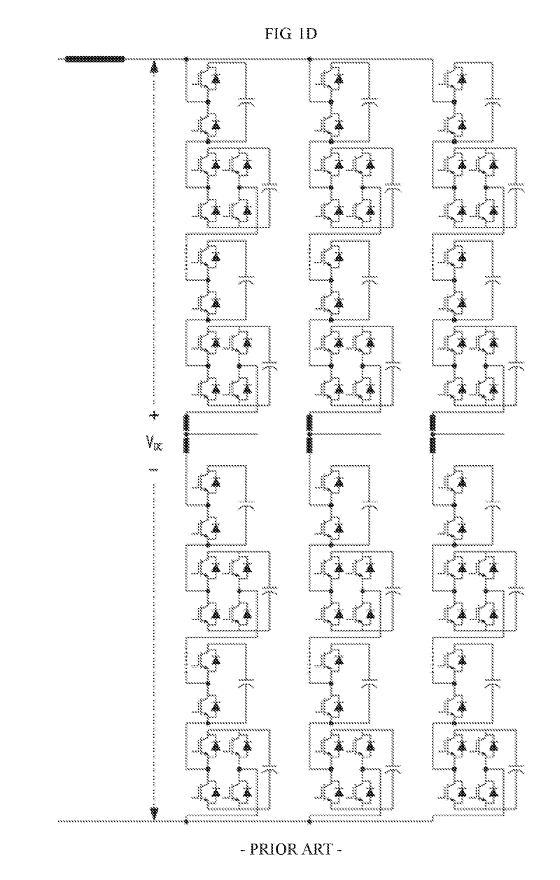

In the topology of the structure of FIG. 1A, a voltage of 0 or less (i.e., minus voltage) of the bold dotted line plot 460 may not be synthesized but, according to the present disclosure, a lower arm is bipolar and, thus, a minus voltage of 0 or less may be synthesized.

The bold plot 450 indicates a voltage reference value of an upper arm of FIG. 7A and the bold dotted line plot 460 indicates a voltage reference value of a lower arm of FIG. 7A. Conventionally, a modulation index of an HVDC system does not exceed 1 and, thus,

$$\frac{Vdc rated}{2}$$

is greater man V*ₓₛ and, based on this, a voltage reference value of 0 to V_{dc} may be inevitably obtained. However, the DC voltage reference value, the AC voltage reference value, and the circulating current voltage reference value for synthesize of the bold dotted line plot 460 may be synthesized in the range of −V_{dc} to +V_{dc}. Accordingly, when command values of an upper arm and a lower arm are summed, a DC terminal voltage may be synthesized and, accordingly, a DC voltage may be actively controlled.

When a DC voltage is actively controlled, this means that it is possible to normally drive a system by lowering a DC voltage in the case of emergency such as DC fault or in the case in which a DC voltage is lowered and the system needs to be controlled. In particular, in the case of emergency, a corresponding DC voltage may be lowered at high response speed to lower fault current and, thus, devices included in the system may be prevented from being destroyed and damaged.

In the case of an asymmetric MMC, control command values that have been used in a symmetric MMC need to be changed. In this case, a DC voltage reference value may be calculated by directly changing a DC voltage value as illustrated in FIG. 7A. In the case of an AC voltage reference value, amplitude of a DC voltage needs to be changed and, thus, power of a DC terminal may be changed. The changed DC terminal power needs to be applied to calculate AC power and the calculated. AC power needs to be applied to a feed forward value. A command value for internal power control also needs to use a DC voltage value as a circulating current DC component for power of each leg and, thus, the DC voltage needs to be calculated and, control via circulating current positive-sequence also includes a DC voltage value and, thus, a DC voltage value applied to an asymmetric MMC needs to be used. In particular, in the case of a circulating current positive-sequence, feed forward power needs to be calculated and applied due to a DC voltage difference between an upper arm and a lower arm.

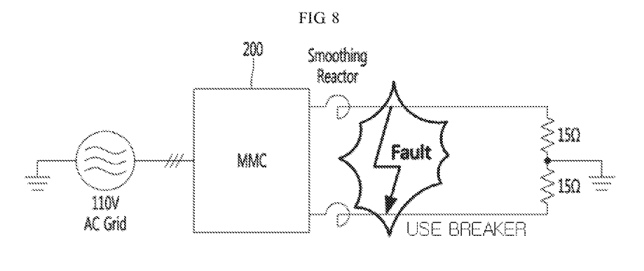

FIG. 8 is a diagram illustrating the case in which DC fault occurs in an MMC according to an exemplary embodiment of the present disclosure.

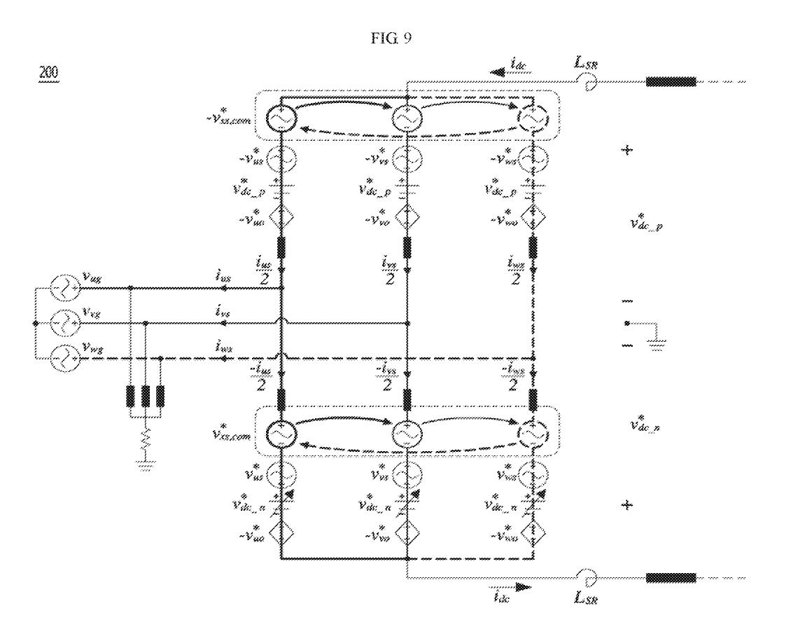

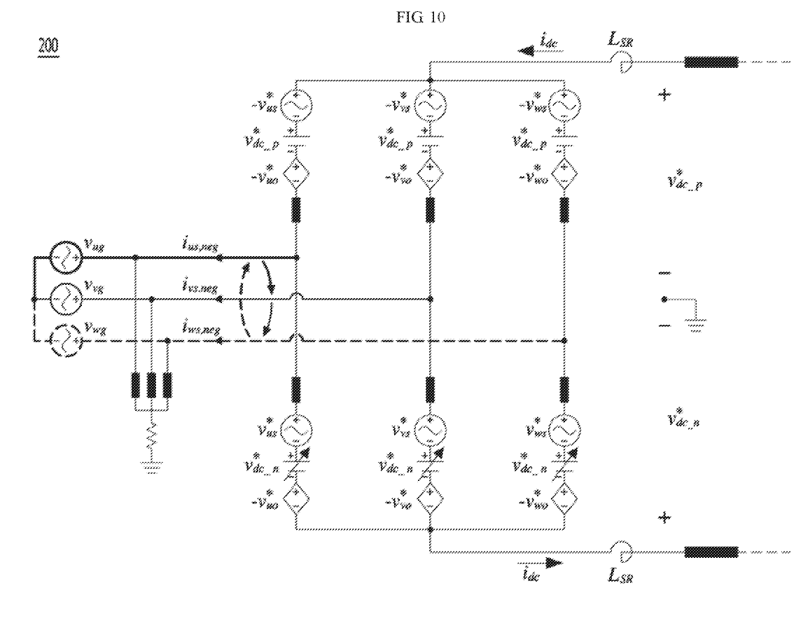

DC pole to pole fault may occur in an asymmetric MMC 200. This corresponds to a most serious case of DC fault. In general, in the case of a DC overhead line, a pole to pole accident momentarily occurs in the DC overhead line due to lightening and so on and, then, the DC overhead line may be recovered. In this case, when DC fault occurs and, then, until the DC overhead line is recovered, internal power of the asymmetric MMC 200 needs to be maintained. However, when DC fault occurs, DC current needs to be controlled to be 0 and, thus, control using a DC component of circulating current may not be possible. In order to overcome this problem, the present disclosure proposes two control schemes for maintaining internal power of the asymmetric MMC 200. Hereinafter, the two control schemes will be described below with reference to FIGS. 9 and 10.

FIG. 9 is a diagram for explanation of a control method for controlling internal power of an MMC according to an exemplary embodiment of the present disclosure.

According to an exemplary embodiment of the present disclosure of a control method for maintaining internal power, a common voltage may be generated to maintain power of each leg included in the MMC 200. In this case, the common voltage needs to be applied to an AC output and, thus, reactive power needs to be unconditionally supplied to a system. Accordingly, only positive-sequence current is used and, thus, distortion may not occur in grid current. However, fundamental wave ripple may be generated in a leg terminal.

FIG. 10 is a diagram for explanation of a control method for maintaining internal power of an MMC according to another exemplary embodiment of the present disclosure.

According to another exemplary embodiment of the present disclosure of a control method for maintaining internal power, opposite-sequence current may be permitted to flow in a power system of the MMC 200 to maintain power of a leg using the opposite-sequence current. In this case, it is not necessary to supply reactive power and, thus, control is independent. However, some opposite-sequence current is generated and, thus, AC current distortion may occur. Here, opposite-sequence current refers to current that flows in an opposite direction to positive-sequence current flowing in three phases. For example, with regard to three phases including A-phase, B-phase, and C-phase, current flowing in an order of A-phase, B-phase, and C-phase is positive-sequence current and current flowing in an order of A-phase, C-phase, and B-phase is opposite-sequence current.

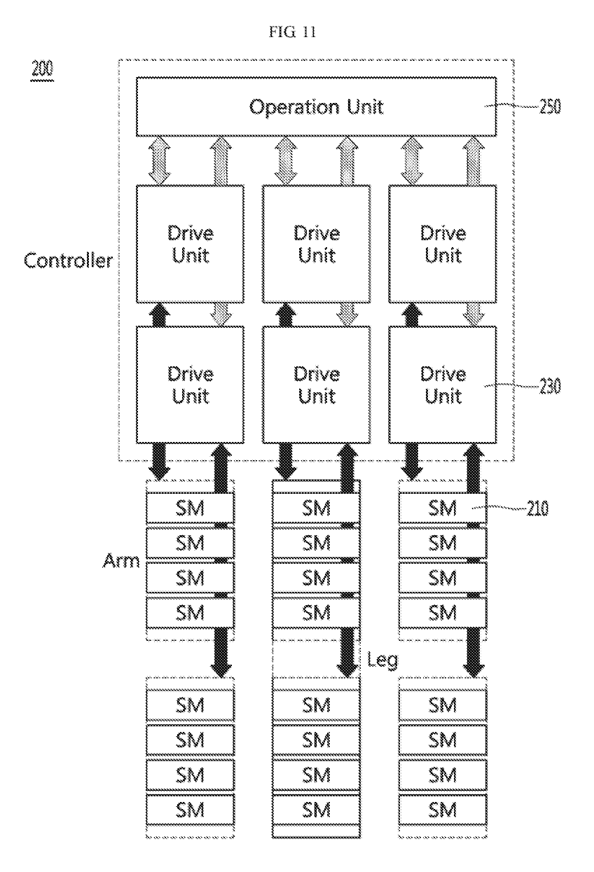

FIG. 11 is a diagram for explanation of a control structure of an MMC according to an exemplary embodiment of the present disclosure.

The MMC 200 according to an exemplary embodiment of the present disclosure may include an HVDC system 100. In this case, the number of the sub modules 210 constituting an arm is high and, thus, a controller for controlling drive of a plurality of arms may be configured as a hierarchical structure in order to effectively control the plurality of arms. In detail, the controller may include a drive unit 230 and an operation unit 250.

The drive unit 230 may be configured to correspond to each arm. In this case, the drive unit 230 may control each corresponding arm. The drive unit 230 may correspond to the sub controllers 230 illustrated in FIG. 2.

The operation unit 250 may commonly control the plurality of drive units 230. The operation unit 250 may correspond to the central controller 250 illustrated in FIG. 2.

The control structure illustrated in FIG. 11 may be basically the same as a structure of a controller for controlling an MMC including only the conventional half-bridge structure sub module 210 or the full-bridge structure sub module 210. That is, in the MMC 200 according to an exemplary embodiment of the present disclosure, types of the sub modules 210 constituting each arm may be the same. Accordingly, a structure of a controller of an MMC configured in such a way that only existing one type of sub module 210 constitutes an arm may be employed. Accordingly, compared with an MMC configured with various types of sub modules 210 with respect to one arm, control complexity may be remarkably lowered.

When control complexity is lowered, an existing algorithm (i.e., algorithm of the case in which an arm is configured with only one type of the sub module 210) may be applied in an accident such as separation of the sub module 210 and there are high advantages in terms of system design and maintenance. For example, when half-bridge type and full-bridge type sub modules 210 coexist in one arm, a controller needs to be differently designed according to a type of the sub module 210. However, in the case of the MMC 200 having a topology proposed according to the present disclosure, it may be possible to use a controller of an MMC configured with only the existing single sub module 210 and it may be possible to simply change and apply an algorithm of a corresponding controller.

FIG. 12 is a diagram illustrating a structure of a high voltage DC transmission (HVDC) system including an MMC according to an exemplary embodiment of the present disclosure.

As illustrated in FIG. 12, the HVDC system 100 may include a power generation part 101, a transmission-side AC part 110, a transmission-side power transformer part 103, the DC transmission part 140, a demand-side power transformer part 105, a demand-side AC part 170, a demand part 180, and a control part 190.

The transmission-side power transformer part 103 may include a transmission-side transformer part 120 and a transmission-side AC-DC converter part 130. The demand-side power transformer part 105 may include a demand-side DC-AC converter part 150 and a demand-side transformer part 160.

The power generation part 101 may generate 3-phase AC power. The power generation part 101 may include a plurality of electric power stations.

The transmission-side AC part 110 may transmit the 3-phase AC power generated by the power generation part 101 to a DC transforming station including the transmission-side transformer part 120 and the transmission-side AC-DC converter part 130.

The transmission-side transformer part 120 may isolate the transmission-side AC part 110 from the transmission-side AC-DC converter part 130 and the DC transmission part 140.

The transmission-side AC-DC converter part 130 may convert 3-phase AC power corresponding to output of the transmission-side transformer part 120 into DC power.

The DC transmission part 140 may transmit DC power of a transmission side to a demand side.

The demand-side DC-AC converter part 150 may convert the DC power transmitted to the DC transmission part 140 into 3-phase AC power. In this case, the demand-side DC-AC converter part 150 may constitute the MMC 200 according to an exemplary embodiment of the present disclosure. The MMC 200 may convert. DC current into AC current using the plurality of sub modules 210.

The demand-side transformer part 160 may isolate the demand-side AC part 170 from the demand-side DC-AC converter part 150 and the DC transmission part 140.

The demand-side AC part 170 may provide 3-phase AC power corresponding to output of the demand-side transformer part 160 to the demand part 180.

The control part 190 may control at least one of the power generation part 101, the transmission-side AC part 110, the transmission-side power transformer part 103, the DC transmission part 140, the demand-side power transformer part 105, the demand-side AC part 170, the demand part 180, the control part 190, the transmission-side AC-DC converter part 130, and the demand-side DC-AC converter part 150. In particular, the control part 190 may control timing of turn-on and turn-off of a plurality of valves in the transmission-side AC-DC converter part 130 and the demand-side DC-AC converter part 150. In this case, the valve may correspond to a thyristor or an insulated gate bipolar transistor (IGBT).

According to the exemplary embodiments of the present disclosure, an upper arm and a lower arm may be configured with a sub module driven in different manners (unipolar and bipolar manners) and, thus, loss in a system in a normal state may be reduced and DC over current in the case of DC fault may be prevented, compared with a conventional MMC configured with a single type sub module.

Various types of sub modules may not coexist in one arm and different types of sub modules may be installed for respective arms so as to basically configure controllers for respective arms and, thus, it may be possible to apply simple control.

In addition, an MMC proposed according to the present disclosure may be flexibly operated with respect to a DC terminal voltage and, thus, when a plurality of lifts is present, it may be possible to control various situations such as the case in which DC fault occurs or current control in a hybrid system with a current source converter (CSC) is achieved and system reliability may be enhanced with comparatively low investment costs compared with the case in which all sub modules are configured in a bipolar manner.

The present disclosure described above may be variously substituted, altered, and modified by those skilled in the art to which the present disclosure pertains without departing from the scope and sprit of the present disclosure. Therefore, the present disclosure is not limited to the above-mentioned exemplary embodiments and the accompanying drawings.

What is claimed is:

1. A modular multi-level converter (MMC) comprising:
two arms comprising different types of sub modules according to the respective arms;
two sub controllers corresponding to the two arms, respectively, and configured to separately control the two arms, respectively; and
a central controller configured to determine a switching operation condition of the sub module and to output a switching signal corresponding to the switching operation condition to each of the two sub controllers,
wherein the two sub controllers control the respective corresponding arms based on the switching signal and, upon receiving a voltage change switching signal for controlling a voltage applied to one of the two arms from the central controller, change the voltage applied to one of the two arms based on the voltage change switching signal.

2. The MMC according to claim 1, wherein the voltage change switching signal comprises data about a voltage reference value applied to one of the two arms.

3. The MMC according to claim 2, wherein the voltage reference value applied to one of the two arms comprises a direct current (DC) voltage reference value and an alternating current (AC) voltage reference value applied to a corresponding arm, and an internal power control constant of the corresponding arm.

4. The MMC according to claim 3, wherein the internal power control constant has a constant for maintaining the two arms at a constant voltage.

5. The MMC according to claim 1, wherein the sub module is configured with one of a half-bridge type, a full-bridge type, and a neutral point clamped (NPC) type.

6. The MMC according to claim 5, wherein:
the two arms comprise an upper arm and a lower arm; and
the upper arm comprises a half-bridge type sub module and the lower arm comprises a full-bridge type sub module.

7. The MMC according to claim 6, wherein the central controller controls a sub controller corresponding to the lower arm to control a DC voltage applied to the lower arm when DC over current is generated in a system comprising the MMC.

8. The MMC according to claim 7, wherein the central controller controls the sub controller corresponding to the lower arm to control the DC voltage applied to the lower arm and to synthesize a DC voltage applied to the upper arm and the DC voltage applied to the lower arm to voltage 0.

9. The MMC according to claim 8, wherein:
the DC voltage applied to the upper arm is
$$\frac{Vdc rated}{2} ;$$
and
the sub controller corresponding to the lower arm controls amplitude of the DC voltage applied to the lower arm in the range of
$$- \frac{Vdc rated}{2} to \frac{Vdc rated}{2} .$$

10. The MMC according to claim 1, wherein the two arms each comprises three arms.

11. The MMC according to claim 1, wherein the central controller controls the two sub controllers to maintain internal power of the MMC.

12. The MMC according to claim 11, wherein the central controller generates a common voltage to maintain power of each of the two arms and applies the generated common voltage to an AC output terminal of each of the two arms.

13. The MMC according to claim 11, wherein the central controller permits opposite-sequence current at a power system of the MMC to maintain power of each of the two arms.

14. The MMC according to claim 1, wherein:
the two arms each comprise an upper arm and a lower arm that each comprise three arms corresponding to three phases, respectively; and
the upper arm comprises a first type sub module and the lower arm comprises a second type sub module.

15. The MMC according to claim 1, wherein:
the two arms each comprise an upper arm and a lower arm that each comprise three arms corresponding to three phases, respectively; and
the upper arm and the lower arm each comprise different types of sub modules and the sub modules have different types according to the three phases.
